(19) United States
(12) Patent Application Publication
(10) Pub. No.: US 2006/0005460 A1
(43) Pub. Date: Jan. 12, 2006

(54) Fish dimension recording towel

(76) Inventor: Mark E. Bittrick, Janesville, WI (US)

Correspondence Address: REINHART BOERNER VAN DEUREN S.C.;ATTN: LINDA KASULKE, DOCKET COORDINATOR, 1000 NORTH WATER STREET, SUITE 2100, MILWAUKEE, WI, 53202, US

(21) Appl. No.: 10/878,735

(22) Filed: Jun. 28, 2004

(51) Int. Cl. A01K 83/00

(52) U.S. Cl. 43/43.4

(57) ABSTRACT

A fish dimension recording towel and a method of using the fish dimension recording towel are disclosed which are for use in recording the non-weight measurement of a live trophy fish in a catch, photograph, and release fishing program. The fish dimension-recording towel includes a water absorbent fabric having a top side having a non-smooth top surface with a grid portion with grid units having known dimensions thereon. The towel is wetted and placed onto a flat surface with the grid portion exposed. The trophy fish is positioned on the grid portion and two view photographs are taken of the fish on the grid portion of the fish dimension recording towel, one with the fish on its side and the other with the fish rotated about ninety degrees, after which the fish is released. From the printed photographs, the grid units covered by the fish in each of the areas where measurement data is needed may be counted. The length, width, and thickness of the trophy fish, as well as the relative locations of its features, can be calculated and used to create a dimensionally correct replica of the trophy fish.

### BACKGROUND OF THE INVENTION

### FIELD OF THE INVENTION

The present invention relates generally to apparatus for measuring live fish, and more particularly to an apparatus for recording the non-weight measurements of a live trophy fish.

Fishing is a recreational sport enjoyed by many fishing enthusiasts, both men and women. Herein throughout fishing enthusiasts are also referred to as “anglers” or “fishermen” or “fisherman.” Although some anglers fish recreationally to keep or kill the fish that are caught, many fishing enthusiasts participate in catch and release programs for “trophy fish.” A trophy fish is a fish that exceeds size expectations for its species. A trophy fish may also be referred to as a “record” fish.

Trophy fish are scarce and require a skilled angler to catch them. Conservation groups, outfitters, resort owners, and others involved in the recreational fishing industry in the United States and Canada recognize trophy fish are their greatest resource. Fishermen spend billions of dollars each year in pursuit of these trophy fish. Thus the recreational fishing industry has been promoting “catch and release programs” for trophy fish for a number of years. The catch and release programs allows a greater number of anglers to experience the thrill and achievement of catching and landing a trophy fish.

A large number of fishing outfitters in the United States and Canada do not allow trophy fish to be kept or killed by the fisherman catching them. Catch and release programs were adopted and promoted by these groups for a number of reasons, for example, because it takes a number of years to grow a fish to trophy status and because there are only a limited number of trophy fish available to be caught. The trend in the recreational fishing industry now is to promote “catch, photograph, and release” (also referred to herein as “CPR”) programs.

Although the photograph may be used to document the fisherman's success, one of the biggest obstacles to “CPR” is that the fisherman often times is not satisfied with just a photograph of his/her prize trophy fish. Nor is a graphic image of the actual fish on a sheet of material sufficient for many fishermen (see, U.S. Pat. No.6,055,751, to Easthope, showing handling a live fish and inking one side of the body of the live fish, bringing the ink coated side body portion of the fish into contact with the sheet material whereby an impression of the live fish is transferred to the sheet material). The fisherman wants something to hang on the wall. What the fisherman wants is a trophy that replicates the trophy fish in all its glorious detail to commemorate the fisherman's achievement. What the fisherman wants is a trophy that is a realistic or true looking replica of the trophy fish the fisherman caught and then released.

Fishermen who had previously been able to supply a taxidermist with the actual fish to mount as a trophy are no longer able to provide the taxidermist with a fish to mount under the catch and release programs or the “CPR” programs. This practice of catch and release programs or “CPR” programs and the prohibitions against keeping or killing trophy fish has spawned a new industry for taxidermists. Taxidermists have responded by developing a process for creating very realistic looking replicas of the actual fish trophies that they had previously mounted. Now taxidermists generally ask the fisherman to measure the length and girth of the fish, to provide the fish's weight and to provide a photograph of the trophy fish. From those figures and knowing the species of the trophy fish, the taxidermist approximates what the trophy fish looked like and creates a replica.

Unfortunately for most trophy fish fishermen, what they get back is a replica of the species they caught with the replica only having the same length as the fish they caught. Certain providers of replicas make no attempt to recreate the trophy fish in the photograph they received from the fisherman. Instead, a replica that the taxidermist has in stock for that species of fish that has the same length as the trophy fish caught is the trophy the fisherman gets.

Often, the trophy does not look anything like the fish in the fisherman's photograph of his/her trophy fish. This is very disappointing to the fisherman. A number of taxidermists have recognized that the true trophy fishermen does not just want any fish replica for the trophy; rather the trophy fisherman wants a replica of a fish that looks exactly like the trophy fish he/she caught. These taxidermists started to incorporate other measurements as well as length measurements, into each replica and tried to paint the replica nearer the actual colors of the trophy fish as provided in the photographs sent to them by the fisherman. Unfortunately, all the measurement information the taxidermist generally gets are length, girth, and weight. Thus, the taxidermist has to look at the photographs and guess the rest of the information needed to create the replica.

What the taxidermists need are more measurements of the live trophy fish, but taking those measurements is not easy for the fisherman. The fish is hopefully very much alive and very active, squirming and flipping about during the process. There is also a very small window of time for the fisherman to accomplish this task without running the risk of killing the trophy fish because it is out of the water too long. A typical way to take the dimensional measurements for the taxidermist to use for making the replica for the trophy is for the fisherman to take some sort of tape measure or ruler and take the different length and girth measurements.

A taxidermist could produce a better replica if the taxidermist had more measurements. The problem with getting more measurements, beside the fish's activity and movement, is that as one moves down the body of the fish and takes additional measurements, the taxidermist has no way of knowing where the subsequent measurements are relative to each other. In other words, is the second measurement five centimeters (two inches) from the first measurement or ten centimeters (four inches) from the first measurement, and in which direction are the subsequent measurements taken?

The taxidermist generally needs to know more than can be easily measured during the time frame available while still keeping the fish alive. Keeping a fish out of the water long enough to create the information necessary for the taxidermist would likely kill the fish. Also, repeated handling of the fish can hurt its survival on release. Fish are covered with a protective slime, and excess handling or touching causes this slime to be removed. When the fish is reintroduced into the water, spots where the slime is removed are subject to infection. The serious trophy fish fisherman wants to keep the trophy fish in as good physical condition as is possible.

Another problem for both trophy fish fishermen and taxidermists is inconsistency in providing the necessary measurements to the taxidermist. The taxidermist needs a simple way to determine the physical dimensional measurements of the trophy fish relative to each other, and the process has to be simple for the fisherman and easily repeatable from fisherman to fisherman.

Furthermore, the fisherman does not want to spend a lot of money on any device used for taking the measurements. What the fisherman wants is an inexpensive, uncomplicated, easy to use, virtually fool-proof device for taking measurements of his/her trophy fish for catch, photograph, and release programs.

Measuring devices such as tapes or measuring strips are generally known, but do not meet the fisherman's needs as explained above. For example U.S. Pat. No. 2,932,897, to Huber, discloses pressure sensitive adhesive-sided measuring strips for measuring length. The measuring strips are disposed on a flat base sheet. The flat base sheet is preferably rectangular in form with dimensions suitable to fit in a business mailing envelope of conventional size. The measuring strips are peeled off the base sheet and arranged end-to-end on a supporting surface, such as the edge of a work table, work bench, sewing machine, or the like. The adhesive backing holds the strips on the supporting surface. The base sheet may have additional edge material, not part of the peelable measuring strips, upon which advertising or other information may be printed or affixed.

U.S. Pat. No. 6,115,932, to Fedora, discloses a multi-layered adhesive backed fish ruler construction for attachment to a substrate such as a cooler or a flat surface on a fishing boat. The Fedora fish ruler has thereupon luminous length indicia as well as luminous fish silhouette indicia representative of different species of fish, e.g., sunfish, bluegill, carp, etc. The tail portion of a particular fish of the different species fish indicia are generally aligned with the length indicia corresponding to the minimum legal length for that corresponding species of fish.

Other known patents in the art fish measuring devices include the fish measuring apparatus of U.S. Pat. No. 6,415,521, to Schell. The Schell patent discloses an apparatus for measuring and cutting fish, namely a lighted fish board having a platform having a length measuring scale directly attached to the platform, and a built-in light source attached to the platform. The fish board includes a gripper or clip to hold the fish while it is being measured or cut, and holders such as suction cups to removably attach the bottom of the fish board to a boat seat, dock, or other surface. The Huber, Fedora, and Schell references all fail to solve the problem of repeated handling damaging the fish and keeping the fish out of the water too long.

Other measuring devices are known for measuring human dimensions or those of animals. For example, U.S. Pat. No. 689,361, to Moe, discloses a method of taking photographic measurements for tailoring purposes. A person for whom the tailoring measurements are to be made dons a harness adapted to indicate on the exterior the exact position of certain body parts used in tailoring measurements. Using a camera, a photographer takes photographs of the standing stationary person wearing the harness. A frame having a net of crossed wires or threads located at known equal or fixed distances from each other is used in the process.

The net is interposed between the person and the film of the camera, with the net being located either in the camera or between the camera and the person to be measured, in a predetermined relation to both. Photographs are then taken of the person at various angles. The person stands in a different position for each successive photograph and holds his body and limbs at different angles needed to meet the requirements of the garment to be made. Computations of the dimensions of the garment are made from the lines formed by the net on the photo, knowing the actual dimensions and also the relative distances of the camera and person photographed.

U.S. Pat. No. 4,407,070, to Lowe, discloses an animal measuring apparatus for measuring horses, cows, and the like. The animal stands in front of a vertically hung panel or between a pair of the vertically hung panels. An outer surface of each of the vertically hung panels has scale markings thereon suitable for the animal being measured. The scale markings extend horizontally across the surface of the panel and are spaced from one another at appropriate calibrations for measuring animals. Both the Moe reference and the Lowe reference appear unsuitable to carry in a boat and use to take measurements of trophy fish.

U.S. Pat. Nos. 4,753,031 and 4,839,675, both to Owen, disclose a sophisticated computerized catch and release fish data recording system. The system includes a two-part carrying case having a weighing and measuring subassembly including a scalar measuring grid for measuring fish length and width, a peg upon which the fish is vertically hung which is connected to the weighing subassembly, a pre-focused camera with film and an expandable camera pedestal, a digital readout display for display of the fish's weight, a digital (LCD) readout of other data (the fisherman's name, an old tag number, a new tag number, the lake, the date, the name of a witness, the time, and Social Security number) , a tripod, batteries, a power pack, a power cord, a measuring tape, a computer, a computer keyboard, printer tape, a printer, and electrical circuitry. Unfortunately, many fishermen do not have the economic resources to purchase such an elaborate device, nor do many have the needed computer skills to operate such a system.

The prior art poses problems with excessive handling of the fish to take the needed measurements, with keeping the fish out of the water too long, with difficult sophisticated operation of the measuring device, and the expense to acquire the measuring device, and/or the unsuitability of such devices for use on trophy fish which are to be released back to the fishing grounds in a healthy condition.

Thus, notwithstanding the many known problems with handling and measurement of a trophy fish for purposes of providing measurements to a taxidermist for the purposes of making an accurate or true replica of the trophy fish, the art has not adequately responded to date with a simple-to-use, uncomplicated, and low-cost device to measure a trophy fish, and a method to get the largest most accurate number of measurements of the trophy fish and their relative position to each other in a simple, easily performed process without excessive handling of the trophy fish.

What is needed is an inexpensive (or low cost), uncomplicated, easy-to-use device for a fisherman to use to readily get extremely accurate and complete non-weight physical measurements of his/her trophy fish.

What is needed is an inexpensive, easy to use, uncomplicated device for a fisherman to use in a catch, photograph, and release fishing program to limit the trauma to the trophy fish and to increase the odds of its survival when the fisherman returns the trophy fish to the water.

What is needed is a method of taking physical dimension measurements of a trophy fish using a low cost, uncomplicated, simple-to-use device which benefits taxidermists in determining accurate actual dimensions of the trophy fish for the taxidermist to produce a replica of the trophy fish that looks realistically like the trophy fish the fisherman caught.

What is needed is a simple method of taking physical dimension measurements of a trophy fish using a low cost, uncomplicated, simple-to-use device which also benefits fishing outfitters by instructing the fisherman in the proper protocol of catch and release programs, by minimizing the adverse consequences to the fish that has been caught, and by increasing the survival rates of the trophy fish after they are returned to the water.

What is needed is a simple method of taking physical dimension measurements of a trophy fish caught in a catch, photograph, and release fishing program using a low cost, uncomplicated, simple-to-use device which benefits fishing outfitters by having the name, telephone number, Internet web site, etc. of the outfitter on the device so the photograph of the “trophy fish” taken by a fisherman of his “trophy,” whether being replicated or not, will have advertising information of the outfitter thereon.

Finally, it is also an objective that all of the aforesaid advantages and objectives be achieved without incurring any substantial relative disadvantage.

### SUMMARY OF THE INVENTION

The disadvantages and limitations of the background art discussed above are overcome by the present invention. With this invention a simple-to-use, uncomplicated and low cost device to measure a trophy fish, to get the largest most accurate number of measurements of the trophy fish and their relative position to each other in a simple, easily-performed method without excessive handling of the trophy fish is provided. The device of the present invention is a fish dimension recording towel. It may also be seen that the present invention also teaches a method of using the fish dimension recording towel, for recording the non-weight physical measurement of a live trophy fish in a catch, photograph and release fishing program.

The towel includes a water-absorbent fabric having a top side and an opposite reverse side. The top side has a non-smooth top surface having a grid portion with identically dimensioned grid units in horizontal and vertical directions with known dimensions thereon. The towel is wetted and placed with the reverse side contacting a flat surface. The trophy fish is placed on the grid portion and a top view photograph is taken. The fish is tipped vertically (or rotated about ninety degrees) while still on the grid and a second top view photograph is taken, after which the fish is released. Advantageously, the towel and the method of the present invention limits the trauma to the fish and increases the odds of its survival when the fisherman returns the trophy fish to the water.

The photographs are processed. From the photographs, the grid units covered by the fish in each of the areas where measurement data is needed are counted. The length, width, and thickness of the trophy fish can be calculated by the taxidermist from the photographs. The taxidermist merely counts the number of grid units, preferably squares or rectangles, which are covered and multiplies by the known dimension of the grid unit for each measurement. The calculated dimensions may be used by the taxidermist to create a dimensionally-correct replica of the trophy fish. Advantageously, the towel and the method of the present invention is easy for a fisherman to use to readily get an extremely accurate and complete measurement of his/her trophy fish.

Advantageously, the method of the present invention using the towel of the present invention benefits taxidermists in determining the actual dimensions of the trophy fish to enable the taxidermist to produce a replica of the trophy fish that looks realistically like the trophy fish the fisherman caught. Advantageously, the result is a fisherman who is more satisfied with the dimensional accuracy of the replica of his/her trophy fish.

The top side of the towel may also have blank space thereon sufficient in dimension to allow selected top side indicia to be printed thereon. The top side indicia may be advertising for the seller and/or the distributor of the towels and/or instructions on the use of the towel and/or information relating to a group promoting a fishing event or other indicia. Preferably, the top side indicia includes information relating to at least some of the name, the telephone number, the website address, and the physical address of a seller or distributor of the towel who is a fishing outfitter.

The use of the towel of the present invention by outfitters as promotional items given to fishermen provides advertising benefits to the outfitter. Top side indicia may also include instructions on the catch, photograph, and release program and how to use the towel.

Advantageously, the method of taking physical dimensional measurements of a trophy fish using the towel of the present invention benefits fishing outfitters by instructing the fisherman in the proper protocol of catch and release programs, by minimizing the adverse consequences to the fish that has been caught, and by increasing the survival rates of the trophy fish after they are returned to the water.

Preferably, the reverse side of the towel has reverse side indicia printed thereon. The reverse side indicia may be advertising space sold to one or more businesses for advertising the respective businesses. Advantageously, this can be used further by the seller or distributor to defray the seller's or distributor's costs to have the towels custom produced and also promotes good will between the seller or distributor and the businesses buying advertising space on the towel.

The towel of the present invention is of a construction which is both durable and long lasting, and which may be washed and reused. The towel of the present invention is also of inexpensive construction to enhance its market appeal and to thereby afford it the broadest possible market. As the towel is inexpensive, the towel may be given away by sellers or distributors, such as outfitters, as complimentary items. Finally, all of the aforesaid advantages and objectives are achieved without incurring any substantial relative disadvantage.

### DESCRIPTION OF THE DRAWINGS

These and other advantages of the present invention are best understood with reference to the drawings, in which:

FIG. 1 is a top plan view of a fish dimension recording towel made according to the teachings of the present invention, with a fish shown thereon;

FIG. 2 is a top plan view of the fish dimension recording towel of FIG. 1, with the same fish shown thereon in another orientation;

FIG. 3 is a partial side view of the fish dimension recording towel with the fish shown in the orientation shown in FIG. 2;

FIG. 4 is a rear plan view of the fish dimension recording towel shown in FIGS. 1 through 3; and

FIG. 5 is a top view of an alternate fish dimension measuring towel, without a fish thereon and illustrating another grid unit.

### DETAILED DESCRIPTION OF THE PREFERRED EMBODIMENT

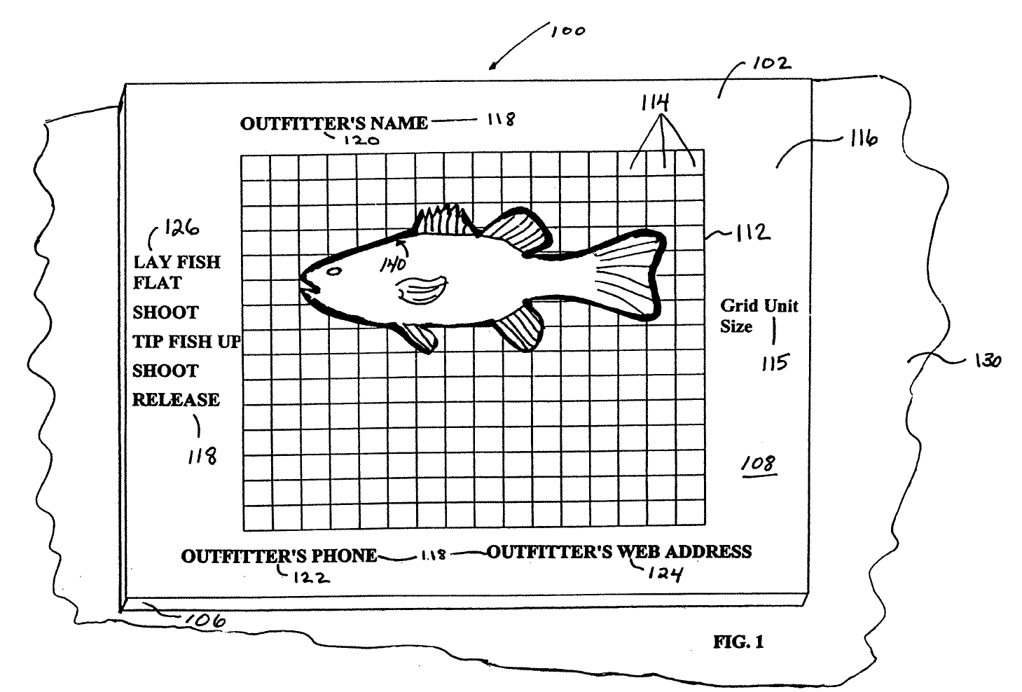

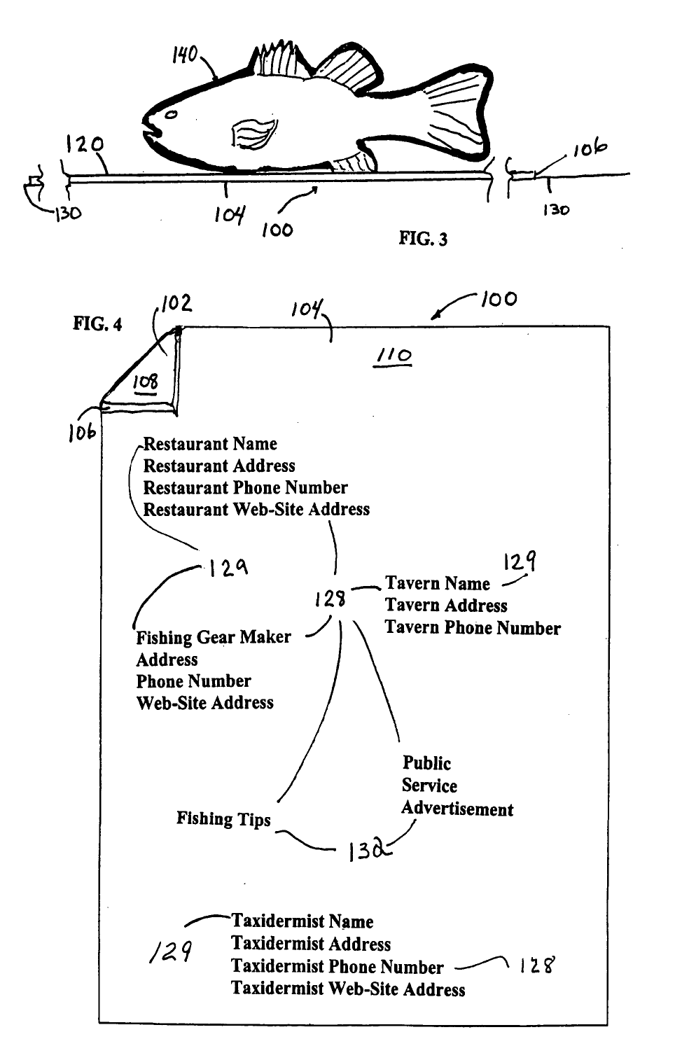

Reference now is made to FIGS. 1 through 5 depicting a preferred fish dimension recording towel generally designated by reference numeral 100. As best shown in FIG. 1, the preferred embodiment of the fish dimension recording towel 100 is an inexpensive (low cost), water absorbent, non-smooth (textured) surfaced fabric or material, preferably a terry cloth towel material or water absorbent material, and most preferably a cotton material.

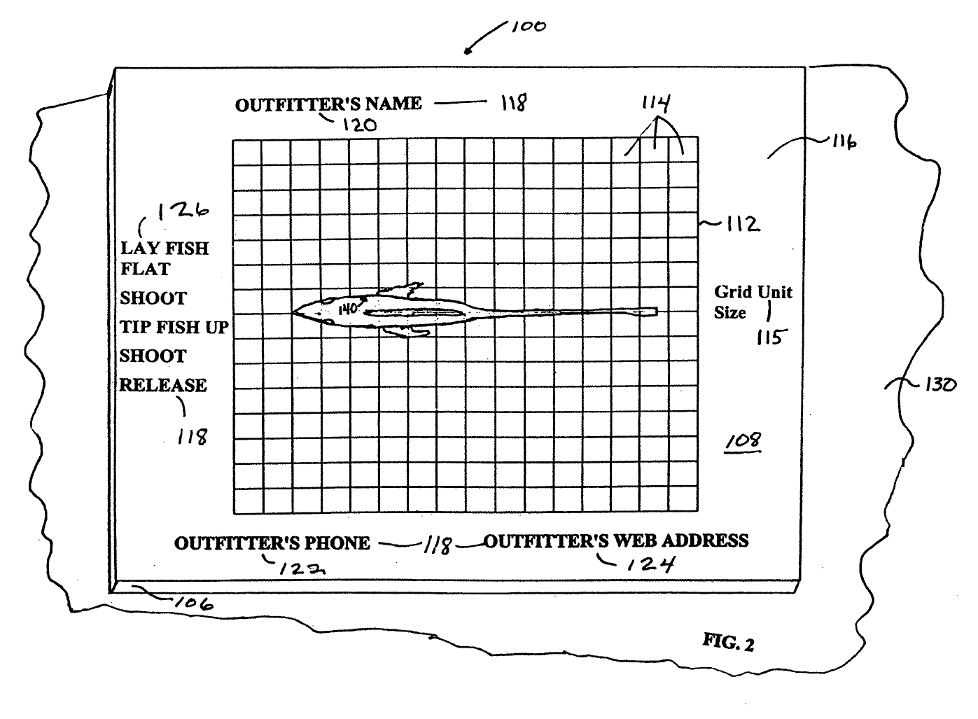

Preferably the fish dimension recording towel 100 is rectangular in shape having length, width, and thickness dimensions, but the fish dimension recording towel 100 alternately may have other shapes. The fish dimension recording towel 100 has a top side 102 shown in FIGS. 1 through 3 and FIG. 5, and an opposite reverse side 104 best shown in FIGS. 2 and 4, with a thickness 106 therebetween. The top side 102 of the fish dimension recording towel 100 has a top surface 108 and the opposite reverse side 104 has a surface 110.

A printed grid 112 is visually apparent on the top surface 108 of the fish dimension recording towel 100. Preferably the grid 112 is printed onto the top surface 108 of the fish dimension recording towel 100. The grid 112 is comprised of a number of dimensioned grid units 114 in horizontal and vertical directions in the printed grid 112 on the top surface 108, which may be identical in size as shown. It will be appreciated by those skilled in the art that the geometry of the grid units 114 may differ from those shown in FIGS. 1, 2, and 5.

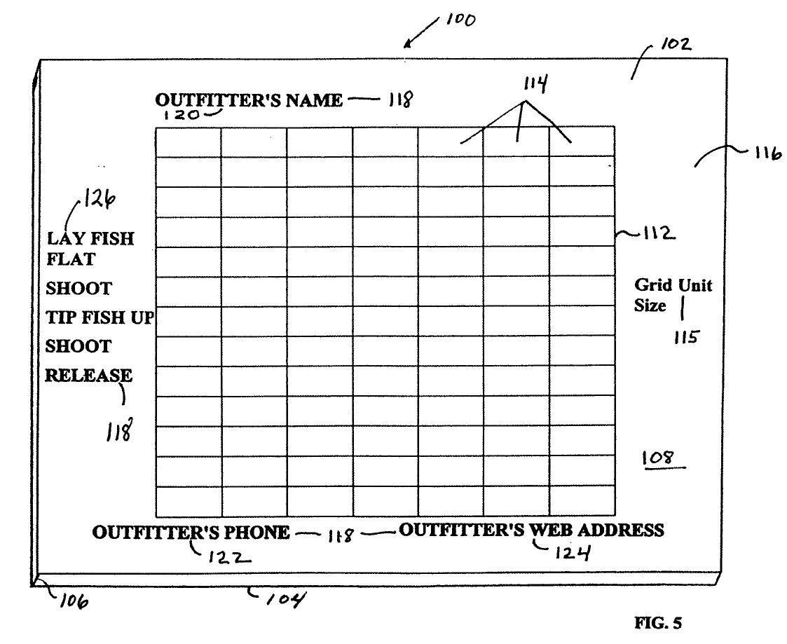

The grid units 114 are of known dimensions (size) which are printed or otherwise placed on the towel. The known dimensions are referred to as “grid unit size” or “scale,” and may be indicated by indicia 115. Preferably, the grid unit 114 is a square (as shown in FIGS. 1 and 2) or a rectangle (as shown in FIG. 5). Most preferably the grid 112 is a plurality of approximately one-inch (approximately 2.5 centimeters) squares, in which case the indicia 115 printed would, for example, read “1 inch squares.”

However, other size squares may be used, for example about one or two centimeter squares may be used. Alternatively, as best shown in FIG. 5, rectangles with known dimensions may be used as the grid unit 114, for example, one-half inch by one inch may be used, in which case the indicia 115 would, for example, be “one-half inch by one inch rectangles.” The fish dimension recording towel 100 shown in FIG. 5 is constructed and used exactly like the fish dimension recording towel 100 shown in FIGS. 1 through 4, with only the geometry of the grid unit 114 and the indicia 115 for the grid unit used being different.

The fish dimension recording towel 100 is also used as an advertising tool. In addition to the grid 112 being printed on the towel, the fish dimension recording towel 100 is sufficiently dimensioned having a blank space portion 116 for other selected indicia 118 to be printed around the grid 112 in the blank space 116. The selected indicia 118 on the top side 102 of the fish dimension recording towel 100 is also referred to herein throughout as “top side indicia 118.”

The top side indicia 118 may be advertising for the seller and/or the distributor of the fish dimension recording towels 100, and/or the top side indicia 118 may be instructions on the use of the fish dimension recording towel 100, and/or the top side indicia 118 may relate to a group promoting a fishing event, and/or the top side indicia 118 may relate to other things, e.g., fishing safety practices in a catch and release program or practices in “CPR” programs or to other entities, e.g., fishing societies specific to a certain fish species, etc. In a preferred embodiment of the fish dimension recording towel 100 of the present invention, the top side indicia 118 includes, but is not limited to, one or more names 120, one or more phone numbers 122, one or more Internet websites 124, one or more types of instructions 126, or any other advertising information requested by the seller or the distributor of the fish dimension recording towel 100.

The amount of blank space 116 around the grid 112 may vary, depending on the amount of the top side indicia 118 to be printed on the fish dimension recording towel 100. The amount of the top side indicia 118 is tailored to the advertising and information providing requirements of the buyer/distributor for the intended user (the fisherman). Preferably the towels 100 are sold to outfitters in the United States and Canada to be used as promotional items with their clients (fishermen), in which case the top side indicia 118 would contain advertising information related to the outfitter, such as, but not limited to, the outfitter's name 120, the outfitter's telephone number 122, and the outfitter's Internet website 124.

The reverse side 104 of the fish dimension recording towel 100 may also be used for advertising purposes or other purposes and bear reverse side indicia 128. Preferably the reverse side indicia 128 includes advertisements 129 for one or more other businesses, such as, but not limited to, the business' names, and one or more of the following: the business'addresses, telephone numbers, Internet websites or web address, or any other information the business wants to use in the advertisement 129. The reverse side indicia 128 is preferably printed on the surface 110 of the reverse side 104 of towel 100.

Such advertisements 129 may include, but are not limited to, advertisements for manufacturers of fishing gear, taxidermists, or for other businesses in the area, such as restaurants, movie theaters, bowling alleys, taverns, grocery stores, etc. The advertisements on the reverse side of the towel may be marketed to these entities. The reverse side indicia 128 may also or instead include non-commercial advertising material 132, such as fishing tips, or public service information or public service advertisements, etc.

The size of the fish dimension recording towel 100 is preferably determined by the type (species) of trophy fish intended to be caught by the fisherman. Smaller game fish (for example, but not limited to, species such as perch, crappies, blue gill, etc.) may be accommodated by a fish dimension recording towel 100 having width by length dimensions of approximately 16 inches by 26 inches (approximately 41 centimeters by 66 centimeters), with a total grid size which is approximately 12 inches by 20 inches (approximately 30 centimeters by 50 centimeters), and preferably with a square grid thereupon, having one-half inch by one-half inch or one inch by one inch sized grid units.

Medium sized game fish (for example, but not limited to species such as trout, bass, walleye, pike, salmon, etc.) may be accommodated by a fish dimension recording towel 100 with dimensions of approximately 28 inches by 56 inches (approximately 71 centimeters by 142 centimeters), with a total grid size which is approximately 20 inches by 48 inches (approximately 50 centimeters by 122 centimeters), and preferably with a square grid thereupon, having one inch by one inch sized grid units.

The fish dimension recording towel 100 has a thickness 106 sufficient that the towel is easily wetted with water, and may be rolled or folded for storage when dry. The grid 112 generally covers all but a one to four inch (2.5 centimeters to 10 centimeters) margin of the towel. The grid 112 has a sufficient number of grid units 114 thereon so that when a fish is placed upon it, the grid 112 will surround the fish on all sides, as shown in FIGS. 1 and 2.

As is known in the art, the grid 112 and the indicia 115, 118, 128 are preferably printed on the fish dimension recording towel 100, but may be applied to the surfaces 108 and 110 of the fish dimension recording towel 100 in other ways known in the art of applying patterns or indicia to fabrics, other than printing.

The fish dimension recording towel 100 of the present invention may be used by the fisherman in a catch, photograph, and release fishing program to acquire measurements of his trophy fish to provide to a taxidermist for the purpose of the taxidermist preparing a more realistic replica trophy of the fish. The fish dimension recording towel 100 may be used, in a catch, photograph, and release fishing program to acquire measurements of a trophy fish caught by the fisherman, according to the following method steps. The fish dimension recording towel 100 of the present invention is selected by the fisherman to record the measurements of his/her trophy fish.

The fish dimension recording towel 100 is unrolled or unfolded from its stored location when it is to be used for purposes of measuring the trophy fish. The fish dimension recording towel 100 is wetted, preferably by dipping the fish dimension recording towel 100 into the water of the lake or river or any other body of water where the fishing occurs or into a bucket of water or any other source of water. The wet fish dimension recording towel 100 is removed from the water and placed on a flat surface 130.

The wet fish dimension recording towel 100 is oriented on a flat surface 130, as shown in FIGS. 1 through 3, so that the grid 112 on the top side 102 is visible to the fisherman and the reverse side 104 is in contact with the flat surface 130. The flat surface 130 may be a boat seat, a floor, a deck, or any other flat surface on the boat (fishing vessel) or any other flat object in the boat or on a pier having a sufficient size that the fish dimension recording towel 100 can be extended in a flat orientation in contact with the surface 130.

There are several reasons for wetting the fish dimension recording towel 100. One reason for wetting the fish dimension recording towel 100 is that the moisture or water in the fish dimension recording towel 100 forces the fish dimension recording towel 100 to lay flat and stay down in contact with the flat surface 130. Another reason is that the wet towel 100 advantageously minimizes physical injury to the fish during the measurement process. The wet towel 100 minimizes the chances of removing large amounts of the protective slime that coats the body of the fish, thereby giving the fish better chances of survival on release.

Yet another reason for wetting the fish dimension recording towel 100 is that the non-smooth surface texture of the wet towel 100 advantageously minimizes slipping of the fish while the fish is being photographed. Plastics or other smooth surfaces make it much more difficult to hold the fish still for photography purposes, and wet plastic or other smooth surfaces may even be worse. Yet another advantage of the wet towel 100 is that it may be reused for measuring another trophy fish as the fish dimension recording towel 100 is easily cleaned by dunking it in the water to remove any slime and any blood resulting from catching and measuring the trophy fish.

After the wet towel 100 is appropriately positioned, supra, as best shown in FIG. 1, the fisherman places or lays or holds his/her trophy fish 140 flat on its side on the top surface 108 of the wet towel 100. The fish 140 is placed anywhere within the grid 112. The fisherman then takes a first top view photograph of the fish 140 on the grid 112 of towel 100. The top view photograph will be a photograph of the fish 140 on the fish dimension recording towel 100 looking similar to that shown in FIG. 1.

As best shown in FIG. 2, the fisherman then tips the fish 140 to a vertical orientation (rotates the fish about ninety degrees) and takes a second top view photograph of the fish 140 on the grid 112 of towel 100 in the vertical orientation. The second top view photograph will be a photograph of the fish on the towel looking similar to that shown in FIG. 2. For either of the photographs, the fish 140 may be placed anywhere on the grid 112 of towel 100 as long as the entire fish 140 is positioned on the grid 112. The fish dimension recording towel 100 may be used for any type (species) of fish as long as the fish is smaller than the total size of the grid 112.

Once the photographs are completed the trophy fish 140 is released into the lake, river or other body of water.

The photographs are processed according to the kind of camera used, film, digital, etc. The processed photographs are given to the taxidermist for use in making a replica for a trophy for the fisherman. Alternatively, the fisherman may merely want to archive these photographs for his/her personal enjoyment to refresh his/her memory of the enjoyable fishing trip or to show the photographs to others.

To determine the physical dimensions of the trophy fish 140, the taxidermist (or anyone else interested in the fish's physical dimensions) merely needs to know the size of the grid units 114 and the amount (or number of them) covered by the fish. The taxidermist simply looks at the photographs and counts the grid units 114 (and portions thereof) covered by the fish 140 in each of the areas where the taxidermists (or other interested party) needs measurements. The counted covered grid units and portions thereof are multiplied by the dimensions (indicia 115) of each grid unit 114 in each selected area in the two photographs.

If the indicia 115 is absent from towel 100, the taxidermist needs to be provided with the dimensions of the grid units 114 to make the calculations. The length and width dimensions of the fish may preferably be determined from the photograph where the fish 140 lies flat on its side, as in FIG. 1. The relationship of the thickness of the fish to the length of the fish may be determined by the photograph where the fish 140 is tipped to the vertical orientation, as shown in FIG. 2.

Anatomical locations on the fish, e.g., fins, gills, eye locations are easily correlated between the two photographs. This information provides the taxidermist all the physical dimension (length, width, and thickness) data that is needed to create a more realistic replica of the trophy fish 140.

The fish dimension recording towel 100 and the method of the present invention provides the fisherman a simple, easily done, reproducible, fool-proof process to get an extremely accurate and complete measurement of his/her trophy fish 140 with the largest most accurate number of measurements of the trophy fish 140 and their relative position to each other. If the fisherman decides to have a replica made, the replica will more closely resemble the fish 140 he/she caught. The fisherman will know that he/she is limiting the trauma to the fish 140 and that use of the fish dimension recording towel 100 and method of the present invention will increase the odds of the fish's survival when the fisherman returns the fish 140 to the water.

In yet another aspect of the present invention, the fish dimension recording towel 100 of the present invention acts as an advertising tool. As shown in FIGS. 1, 2, and 5 advertising information 120, 122, 124 regarding the outfitter may be indicia 118 printed on the surface 108 of the fish dimension recording towel 100. In addition, additional advertising 129 for other businesses may be placed as indicia 128 on the reverse side 104 of the fish dimension recording towel 100 as shown in FIG. 4. Advertising space for advertising 129 may be sold by the outfitter or by the seller or distributor of the towel to the different businesses.

It may therefore by appreciated from the above detailed description of the preferred embodiment of the present invention that the fish dimension recording towel 100 of the present invention may be used as a promotional item for an advertiser with its clients or potential clients. Advantageously, the fish dimension recording towel 100 of the present invention benefits the outfitter by encouraging the catch and release program. The fish dimension recording towel 100 further benefits the outfitter by instructing the fisherman in the proper protocol of catch and release, see indicia 126. The fish dimension recording towel 100 still further benefits the outfitter by minimizing the adverse consequences to the fish that has been caught; thereby increasing the survival rates of the trophy fish, the outfitter's most valuable resource, after they are returned to the water.

Most advantageously, every photograph taken by a fisherman of his trophy fish, whether being replicated by the taxidermist or not, will have the name, telephone number, web site, etc. of the outfitter (indicia 120, 122, 124) thereby providing extremely good advertising for the outfitter, as the photographs will likely be shared with family and friends of the fisherman.

The fish dimension recording towel 100 is preferably made of an inexpensive fabric. After use, the fish dimension recording towel 100 may be rinsed in the water and dried or laundered and dried, then rolled up or folded and stored to be saved for reuse, or to be saved as a souvenir, or to be saved for the advertising information thereon, or alternatively the towel may be merely discarded.

Although the foregoing description of the present invention has been shown and described with reference to particular embodiments and applications thereof, it has been presented for purposes of illustration and description and is not intended to be exhaustive or to limit the invention to the particular embodiments and applications disclosed. It will be apparent to those having ordinary skill in the art that a number of changes, modifications, variations, or alterations to the invention as described herein may be made, none of which depart from the spirit or scope of the present invention. The particular embodiments and applications were chosen and described to provide the best illustration of the principles of the invention and its practical application to thereby enable one of ordinary skill in the art to utilize the invention in various embodiments and with various modifications as are suited to the particular use contemplated. All such changes, modifications, variations, and alterations should therefore be seen as being within the scope of the present invention as determined by the appended claims when interpreted in accordance with the breadth to which they are fairly, legally, and equitably entitled.

What is claimed is:

1. A fish dimension recording towel comprising:
a water-absorbent fabric segment having a top side and an opposite bottom side with a thickness therebetween, said top side of said fabric segment having a non-smooth top surface, said bottom side having a back surface, said fabric segment having a width and a length;
grid indicia located on said non-smooth top surface of said fabric segment, said grid indicia having a plurality of grid units in horizontal and vertical directions thereon, said grid indicia having a width and a length which are of sufficient size to accommodate a fish placed thereupon; and
textual indicia located on at least one of said top surface of said fabric segment and said back surface of said fabric segment.

2. A fish dimension recording towel as defined in claim 1, wherein said fabric segment comprises:
a textured terry cloth cotton fabric.

3. A fish dimension recording towel as defined in claim 1, wherein said grid indicia comprises:
a plurality of identically sized grid units.

4. A fish dimension recording towel as defined in claim 3, wherein said grid units comprises:
a plurality of identically dimensioned squares.

5. A fish dimension recording towel as defined in claim 4, wherein said squares are each approximately one inch square.

6. A fish dimension recording towel as defined in claim 3, wherein said grid indicia comprises:
a plurality of identically dimensioned rectangles.

7. A fish dimension recording towel as defined in claim 6, wherein said rectangles are each approximately one-half inch by one inch in size.

8. A fish dimension recording towel as defined in claim 1, wherein said grid indicia is printed on said top side of said fabric segment.

9. A fish dimension recording towel as defined in claim 1, wherein said top surface comprises:
a border area surrounding said grid indicia in which said grid indicia is not present.

10. A fish dimension recording towel as defined in claim 9, wherein said textual indicia is located on said top surface in said border area.

11. A fish dimension recording towel as defined in claim 10, wherein said textual indicia is also located on said back surface.

12. A fish dimension recording towel as defined in claim 11, wherein textual indicia located on said top surface is related to a first party and textual indicia located on said back surface is related to a second party.

13. A fish dimension recording towel as defined in claim 12, wherein said first party comprises:
either a manufacturer, a distributor, or a seller of said fish dimension recording towel; and wherein said second party comprises:
a business located in the same geographic region as a seller of said fish dimension recording towel.

14. A fish dimension recording towel as defined in claim 1, wherein said textual indicia comprises:
indicia related to at least one of a manufacturer of said fish dimension recording towel, a distributor of said fish dimension recording towel, a seller of said fish dimension recording towel, instructions on use of said fish dimension recording towel, and advertising.

15. A fish dimension recording towel as defined in claim 14, wherein said textual indicia is located both on said top surface of said fabric segment and on said back surface of said fabric segment.

16. A fish dimension recording towel as defined in claim 14, wherein said textual indicia is related to a party which is at least one of a manufacturer of said fish dimension recording towel, a distributor of said fish dimension recording towel, a seller of said fish dimension recording towel, and wherein said textual indicia comprises:
a name of said party and at least one of an address of said party, a telephone number of said party, the address of a website of said party, and advertising information related to said party.

17. A fish dimension recording towel comprising:
a water-absorbent fabric segment having a top side and an opposite bottom side with a thickness therebetween, said top side of said fabric segment having a non-smooth top surface, said bottom side also having a surface, said fabric segment having a width and a length;
grid indicia located on said non-smooth top surface of said fabric segment, said grid indicia having a plurality of grid units in horizontal and vertical directions thereon, said grid indicia having a width and a length which are of sufficient size to accommodate a fish placed thereupon;
textual indicia located on said top surface of said fabric segment and related to at least one of a manufacturer of said fish dimension recording towel, a distributor of said fish dimension recording towel, a seller of said fish dimension recording towel, instructions on use of said fish dimension recording towel, and advertising; and
textual indicia located on said back surface of said fabric segment and related to advertising.

18. A fish dimension recording towel comprising:
a fabric segment having a top side and an opposite bottom side, said top side of said fabric segment having a top surface, said bottom side also having a surface, said fabric segment having a width and a length;
grid indicia located on said non-smooth top surface of said fabric segment, said grid indicia having a plurality of grid units in horizontal and vertical directions thereon; and
textual indicia located on at least one of said top surface of said fabric segment and said back surface of said fabric segment.

19. A method of recording non-weight physical measurements of a fish for a catch, photograph and release program, the method comprising the steps of:
selecting a fish dimension recording towel wherein the towel comprises, a water absorbent fabric having a top-side and an opposite reverse side with a thickness therebetween; the top-side having a non-smooth top surface, the non-smooth top surface having a grid portion thereon, the grid portion having a plurality of grid units, and the opposite reverse side having a surface;
dipping the fish dimension recording towel into water to wet the towel;
removing the wet towel from the water and placing it on a flat surface oriented with the surface of the reverse side of the towel in contact with the flat surface and with the top-side of the towel with the grid portion facing outward;
placing a caught fish on the grid with the fish oriented so that the fish lies flat on one of its sides and is placed anywhere within the grid portion;
taking a first top view photograph of the fish on the towel;
tipping the fish from its side to a vertical position, with the fish disposed anywhere within the grid portion;
taking a second top view photograph of the fish on the towel with the fish in the vertical position; and
removing the fish from the towel and releasing the fish into the water.
